(19) United States
(12) Patent Application Publication
(10) Pub. No.: US 2020/0184349 A1
(43) Pub. Date: Jun. 11, 2020

(54) SYSTEM AND METHOD FOR DESIGNING MACHINE AND DEEP LEARNING MODELS FOR AN EMBEDDED PLATFORM

(71) Applicant: IDL VISION TECH LLP, Pune (IN)

(72) Inventor: Ganesh Bhokare, Pune (IN)

(21) Appl. No.: 16/250,441

(22) Filed: Jan. 17, 2019

(30) Foreign Application Priority Data
Dec. 7, 2018 (IN) 201821046360

(51) Int. Cl. G06N 5/02; G06N 20/00; G06F 8/33

(52) U.S. Cl. CPC G06N 5/027; G06F 8/33; G06N 20/00

(57) ABSTRACT

A system for designing machine and deep learning models for an embedded platform is disclosed. The system includes a storage subsystem configured to store a plurality of datasets, one or more augmented datasets, a plurality of models and one or more frameworks. The storage subsystem includes a database module and a proposal module. The system also includes a code generation subsystem operatively coupled to the storage subsystem. The code generation subsystem is configured to generate a code in a predefined computer language for a selected model. The system also includes an implementation subsystem operatively coupled to the code generation subsystem. The implementation subsystem is configured to generate one or more test cases and one or more use-cases to test the selected model based on a generated code.

### CROSS-REFERENCE TO RELATED APPLICATION

This application claims the benefit of complete patent application having Patent Application No. 201821046360 filed on Dec. 07, 2018 in India.

### BACKGROUND

Embodiments of a present disclosure relates to a system of computing for development particularly to a system and method for designing machine and deep learning models for an embedded platform.

Artificial intelligence is a field of computer science which aims to create intelligent machines in order to perform one or more tasks. The artificial intelligence makes the machines intelligent by training to act like humans by replicating human behaviour and nature. The artificial intelligence is a broader concept which includes machine learning and deep learning approaches. The machine learning approach is used to analyse data and establish models to make predictions and decisions. The machine learning approaches includes classification, regression and clustering. Similarly, the deep learning approach refers to a class of machine learning which is used to perform a plurality of tasks such as recommendation engines, object detection, image classification or speech recognition. Various systems are developed to design and implement one or models of artificial intelligence techniques in a platform to perform the one or more tasks.

Conventionally, system for designing the one or more models of machine learning and deep learning approaches for an embedded platform involves requirement of skilled developers. However, such systems fail in terms of performance and efficiency if the developers from non-technical background especially lacking knowledge and experience in programming, concepts of artificial intelligence, and a plurality of frameworks are involved. Also, the manual intervention for designing the one or more models of the machine learning and the deep learning in such system is time consuming.

Hence, there is a need for an improved system and method for designing machine and deep learning models for an embedded platform in order to address the aforementioned issues.

### BRIEF DESCRIPTION

In accordance with an embodiment of the present disclosure, a system for designing machine and deep learning models for an embedded platform is disclosed. The system includes a storage subsystem configured to store a plurality of datasets, one or more augmented datasets, a plurality of models and one or more frameworks. The storage subsystem includes a database module and a proposal module. The system also includes a code generation subsystem operatively coupled to the storage subsystem. The code generation subsystem is configured to generate a code in a predefined computer language for a selected model. The system also includes an implementation subsystem operatively coupled to the code generation subsystem. The implementation subsystem is configured to generate one or more test cases and one or more use-cases to test the selected model based on a generated code.

In accordance with another embodiment of the present disclosure, a method for designing machine learning and deep learning models for an embedded platform is disclosed. The method includes storing, by a storage subsystem, a plurality of datasets, one or more augmented datasets, a plurality of models and one or more frameworks. The method also includes generating, by a code generation subsystem, a code in a predefined computer language for a selected model. The method also includes generating, by an implementation subsystem, one or more test cases and one or more use-cases to test the selected model based on a generated code.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for designing machine learning and deep learning models for an embedded platform in accordance with an embodiment of the present disclosure;

FIG. 2 illustrates a schematic representation of an exemplary embodiment of a system for designing machine learning and deep learning models for an embedded platform of FIG. 1 in accordance with an embodiment of the present disclosure;

FIG. 3 is a flow chart representing the steps involved in a method for designing machine learning and deep learning models for an embedded platform in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for designing machine learning and deep learning models for an embedded platform. The system includes a storage subsystem configured to store a plurality of datasets, one or more augmented datasets, a plurality of models and one or more frameworks. The storage subsystem includes a database module and a proposal module. The system also includes a code generation subsystem operatively coupled to the storage subsystem. The code generation subsystem is configured to generate a code in a predefined computer language for a selected model. The system also includes an implementation subsystem operatively coupled to the code generation subsystem. The implementation subsystem is configured to generate one or more test cases and one or more use-cases to test the selected model based on a generated code.

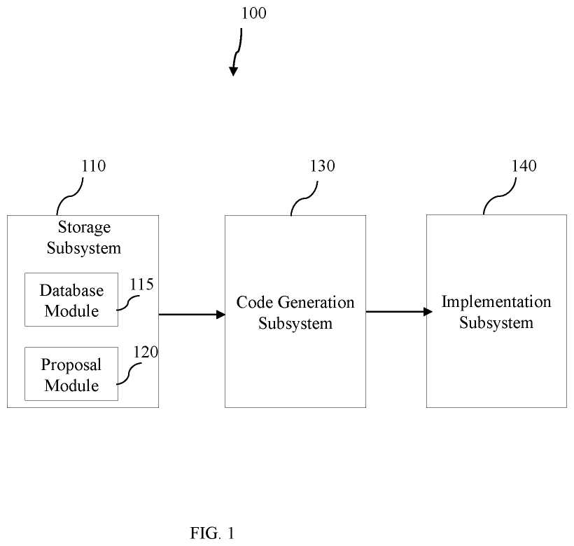

FIG. 1 is a block diagram of a system (100) for designing machine learning and deep learning models for an embedded platform in accordance with an embodiment of the present disclosure. The system (100) includes a storage subsystem (110) configured to store a plurality of datasets, one or more augmented datasets, a plurality of models and one or more frameworks. The storage subsystem (110) includes a database module (115) and a proposal module (120). In one embodiment, the database module (115) may include a plurality of predesigned datasets, one or more predesigned augmented datasets, a plurality of predesigned models and one or more predesigned frameworks. In such embodiment, the plurality of datasets may include a text dataset, a speech dataset, an audio dataset, images dataset, video dataset, radio detection and ranging (RADAR) point datasets or light detection and ranging (LiDAR) point cloud datasets. In some embodiment, the one or more predesigned augmented datasets may include data of images with at least of one or more features such as translation, rotation, scaling, brightness, contrast, clutter and occlusion.

In one embodiment, the plurality of predesigned models may include at least one of an ImageNet model, an AlexNet model, a you only look once (YOLO) model, an Inception model and a visual geometry group (VGG) model. In another embodiment, the one or more predesigned frameworks may include at least one of a TensorFlow framework, a Torch framework, a Keras framework or a Caffe framework.

In one embodiment, the storage subsystem also includes a proposal module (120) which is configured to propose and validate a model in a user-defined framework based on a user-defined dataset. The proposal module (120) receives one or more requests from a user through an interface. In one embodiment, the interface may include at least two modes, wherein the at least two modes may include an abstract mode and a detail mode. In such embodiment, the abstract mode may be utilized by novice developers or designers to design the one or more models with minimum experience. In another embodiment, the detail mode may be utilized by expert designers, researchers or expert developers to design a model from scratch.

The proposal module (120) enables the user to interact with the database module (115) through the user interface for proposing an initial design of the model. In one embodiment, the proposal module (120) may generate and validate a code for a proposed model in the predefined framework by using a plurality of computer languages such as Python, R, Java, Scala or Lisp. The proposal module (120) is also configured to propose one or more training parameters along with valid ranges, minimum and maximum values. One or more proposed parameters helps the user to optimize training time and performance by controlling over-fitting, under-fitting and accuracy.

The system (100) also includes a code generation subsystem (130) operatively coupled to the storage subsystem (110). The code generation subsystem (130) is configured to generate a code in a predefined computer language for a selected model. In one embodiment, the predefined computer language may include a C language. In another embodiment, the predefined computer language may also include a C++ language. In some embodiment, the C or C++ language may generate a source code with a plurality of precision values such as 8-bit, 16-bit and 32-bit precision value. In such embodiment, the C or C++ code may be compiled in at least one of a development platform such as a desktop computer, a graphics processing unit (GPU) machine or a cloud computer system. In some embodiment, the at least one of the development platform may be utilised to maintain a. speed to cost trade-off In one embodiment, the cloud computer system may be utilised for high speed operation. In another embodiment, the GPU machine may be utilised for moderate speed. In yet another embodiment, the desktop computer may be utilised for low speed operation.

The system (100) also includes an implementation subsystem (140) operatively coupled to the code generation subsystem (130). The implementation subsystem (140) is configured to generate one or more test cases and one or more use-cases to test the selected model based on a generated code. In one embodiment, the one or more test cases may be generated to test and clarify one or more features of the selected model for real life applications. In another embodiment, the one or more use-cases may be generated to identify the one or more test cases which tests the selected model.

In one embodiment, the system (100) further includes a streaming subsystem operatively coupled to the code generation subsystem (130) configured to stream the generated code to an embedded hardware platform for deployment in one or more areas. In such embodiment, the one or more areas for the deployment may include but not limited to automotive, robotics, drones, medical imaging or consumer electronics such as camera and mobiles.

In a specific embodiment, the system (100) further includes an optimization subsystem configured to optimise performance of the selected model based on one or more processes. In some embodiment, the one or more processes may include a fine-tuning process configured to control one or more parameters of the selected model. In another embodiment, the one or more processes may also include a fixed-point tuning process configured to optimise architecture by tuning. In such embodiment, the fixed-point tuning may optimise the architecture by offering trade-off among memory, accuracy and computational power of an existing hardware platform. In some embodiment, the optimization of the architecture may be done by reducing the computational power which may reduce power consumption and also may run faster in real time embedded applications.

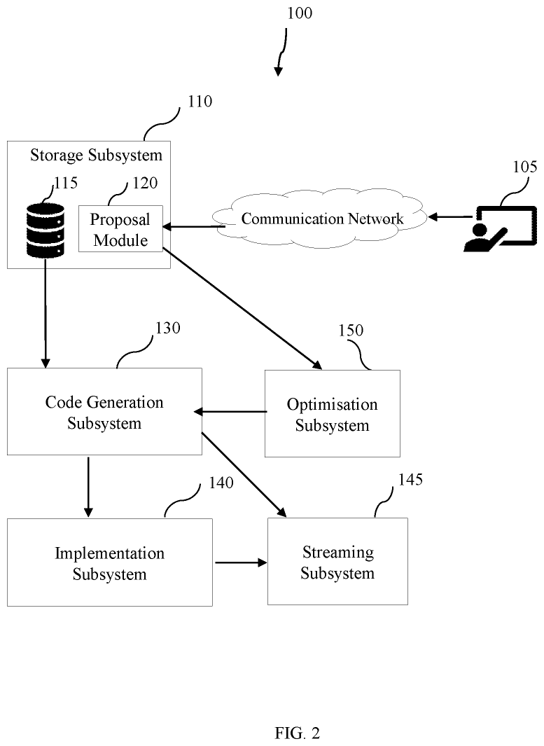

FIG. 2 illustrates a schematic representation of an exemplary embodiment of a system (100) for designing machine learning and deep learning models for an embedded platform of FIG. 1 in accordance with an embodiment of the present disclosure. The system (100) for designing one or more models by a developer is used in deep learning techniques such as convolutional neural network (CNN) for image classification, image recognition or action recognition and deep neural network (DNN) for object and pattern detection or recognition. Similarly, the system (100) is also used for designing the one or more models of machine learning techniques such as deep autoencoders or deep graphical models. For example, if a novice developer or a user (105) wants to design a model for image classification, then the novice developer or the user (105) may start designing the model by using CNN in an embedded platform.

Here, the user (105) may start designing the model for image classification by referring the storage subsystem (110). The storage subsystem (110) is configured to store a plurality of datasets, one or more augmented datasets, a plurality of models and one or more frameworks. The storage subsystem (110) includes a database module (115) configured to store plurality of predesigned datasets, one or more predesigned augmented datasets, a plurality of predesigned models and one or more predesigned frameworks. For example, if the user requires a dataset for classification of images for a dog or a cat, then the user (105) may use the predesigned dataset from the database module (115). The user (105) may perform a task of image classification in the Keras framework by downloading the predesigned image dataset.

In another scenario, if the user (105) does not find a desired dataset for the image classification, then one or more user requirements may be received by a proposal module (120) of the storage subsystem (110). The proposal module (120) is configured to propose and validate a model in a user-defined framework based on a user-defined dataset. The proposal module (120) receives one or more requests from the user (105) through an interface via a communication network. Here, the communication network may include a wireless communication network.

After, the user requirements are received, the proposal module (120) helps in validating the model for classification of the images of animals in the Keras framework by using a Python computer language. The proposal module (120) includes a detail mode and an abstract mode for receiving the one or more queries from the user (105) as per requirement. Here, the detail mode may be used by researchers or expert developers having sufficient knowledge in computer science, mathematics, statistics or operations engineering and management (OEM). On the other hand, the abstract mode may be used by novice developers or less experienced users. The proposal module (120) enables the user (105) to validate the proposed model by training and testing the dataset and using a classifier such as the CNN. The training and the testing set is split in a ratio of 70:30, wherein both the training set and the testing set includes images of cats and dogs as labels. The proposed model is implemented by using the CNN in order to filter the images by using one or more convolution layers. The proposal module (120) also proposes one or more parameters for the proposed model in order to optimize the training time and performance by controlling over-fitting, under-fitting and accuracy.

The system (100) also includes an optimisation subsystem (150) configured to optimise performance of a selected model after proposition by the user (105) based on one or more processes. For example, the one or more processes for the optimisation may include a fine-tuning process configured to control one or more parameters of the selected model. In another embodiment, the one or more processes may also include a fixed-point timing process configured to optimise architecture by tuning. Here, the fixed-point tuning may optimise the architecture by offering trade-off among memory, accuracy and computational power of an existing hardware platform on which the image classification is carried out. The optimization of the architecture may be done by reducing the computational power which may reduce power consumption and also may run faster in real time embedded applications.

After, code optimisation is done for the selected model, then a code generation subsystem (130) automatically generates a library code or test harness in a predefined computer language such as C++. The C++ code is used as a reference floating point and fixed-point code with all 3 different precision as 8-bit, 16-bit or 32-bit precision. In such embodiment, the C or C++ code may be compiled in at least one of a development platform such as a desktop computer, a graphics processing unit (GPU) machine or a cloud computer system. In some embodiment, the at least one of the development platform may be utilised to maintain a speed to cost trade-off In one embodiment, the cloud computer system may be utilised for high speed operation. In another embodiment, the GPU machine may be utilised for moderate speed. In yet another embodiment, the desktop computer may be utilised for low speed operation.

The library code is further optimized and if performance is satisfied, then the C++ code is tested for porting into real-life applications.

The system (100) includes an implementation subsystem (140) which is configured to generate one or more test cases and one or more use-cases to test the selected model based on a generated library code in C++. Here, the one or more test cases tests and clarifies one or more features of the selected model for real life applications. Similarly, one or more use-cases may be generated to identify the one or more test cases which tests the selected model. The selected model after testing process is used for real-life applications and also ported into the embedded platform as a reference model for future designs. Also, such reference model may keep enhancing one or more new features automatically.

In one embodiment, the system (100) further includes a streaming subsystem (145) operatively coupled to the code generation subsystem (130) configured to stream the generated. code to an embedded hardware platform for deployment in one or more areas. In such embodiment, the one or more areas for the deployment may include but not limited to automotive, robotics, drones, medical imaging or consumer electronics such as camera and mobiles.

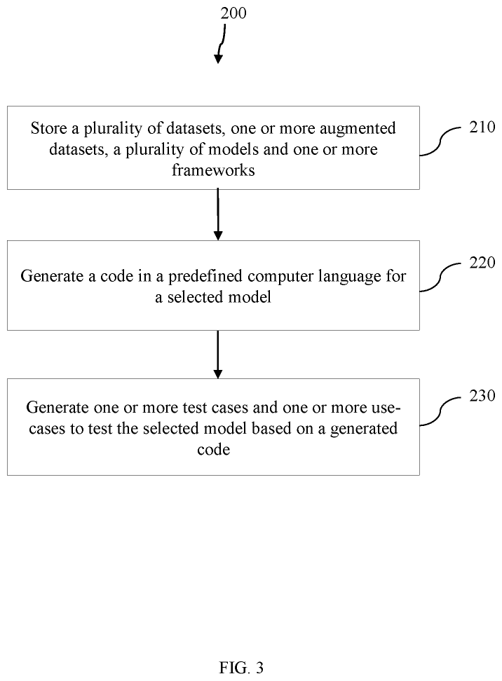

FIG. 3 is a flow chart representing the steps involved in a method (200) for designing machine learning and deep learning models for an embedded platform in accordance with the embodiment of the present disclosure. The method (200) includes storing, by a storage subsystem, a plurality of datasets, one or more augmented datasets, a plurality of models and one or more frameworks in step 210. In one embodiment, storing a plurality of predesigned datasets, one or more predesigned augmented datasets, a plurality of predesigned models and one or more predesigned frameworks includes storing the plurality of predesigned datasets, the one or more predesigned augmented datasets, the plurality of predesigned models and the one or more predesigned frameworks in a database module. In such embodiment, storing the plurality of datasets may include the storing of a text dataset, a speech dataset, an audio dataset, images dataset, video dataset, radio detection and ranging (RADAR) point datasets or light detection and ranging (LiDAR) point cloud datasets.

In some embodiment, storing the one or more predesigned augmented datasets may include the storing of data of images with at least of one or more features such as translation, rotation, scaling, brightness, contrast, clutter and occlusion in the database module.

In one embodiment, storing the plurality of predesigned models may include the storing of at least one of an ImageNet model, an AlexNet model, a you only look once (YOLO) model, an Inception model and a visual geometry group (VGG) model. In another embodiment, storing the one or more predesigned frameworks may include the storing of at least one of a TensorFlow framework, a Torch framework, a Keras framework or a Caffe framework.

In one embodiment, proposing and validating a model in a user-defined framework based on a user-defined dataset may include proposing the model through a user interface by a proposal module. In such embodiment, proposing and validating the model in the user-defined framework based on the user-defined dataset may include validating the model by generating a code using a plurality of computer languages such as Python, R., Java, Scala or Lisp. In some embodiment, proposing one or more training parameters may also include proposing the one or more training parameters for the proposed model with valid ranges, maximum and minimum values.

The method (200) also includes generating, by a code generation subsystem, a code in a predefined computer language for a selected model in step 220. In one embodiment, generating the code may include generating the code for a selected model in the predefined computer language such as C language or C++ language. in some embodiment, generating the code in the C language or C++ language may include generating the code with a plurality of precision values such as 8-bit, 16-bit and 32-bit precision value. In a specific embodiment, the method further includes generating the code based on the selected model in the predefined computer language for porting in correspondence to a heterogeneous hardware platform.

The method (200) also includes generating, by an implementation subsystem, one or more test cases and one or more use-cases to test the selected model based on a generated code in step 230. In some embodiment, generating the one or more test cases may include generating the one or more test cases for testing and clarifying one or more features of the selected model for real-life applications. In another embodiment, generating the one or more use-cases may include generating the one or more use-cases for identifying the one or more test-cases which tests the selected model.

Various embodiments of the present disclosure enable the user with basic background knowledge to design the one or more models of machine learning and deep learning in an embedded platform within a predefined time.

Moreover, the present disclosed system stores a plurality of predesigned datasets and one or more predesigned models which helps the novice developer or the user for quick reference and porting of such models in real-life applications.

Furthermore, the present disclosed system helps in designing one or more customised models based on one or more requirements of the user.

In addition to, the present disclosed system also generates one or more test cases or one or more use-cases in order to test the generated code for the selected model.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for designing machine learning and deep learning models for an embedded platform comprising:
a storage subsystem configured to store a plurality of datasets, one or more augmented datasets, a plurality of models and one or more frameworks, wherein the storage subsystem comprises a database module and a proposal module;
a code generation subsystem operatively coupled to the storage subsystem and configured to generate a code in a predefined computer language for a selected model; and
an implementation subsystem operatively coupled to the code generation subsystem and configured to generate one or more test cases and one or more use-cases to test the selected model based on a generated code.

2. The system as claimed in claim 1, wherein the database module comprises a plurality of predesigned datasets, one or more predesigned augmented datasets, a plurality of predesigned models, and one or more predesigned frameworks.

3. The system as claimed in claim 2, wherein the plurality of predesigned datasets comprises a text dataset, a speech dataset, an audio dataset, images dataset, video dataset, radio detection and ranging (RADAR) point datasets or light detection and ranging (LiDAR) point cloud datasets.

4. The system as claimed in claim 2, wherein the plurality of predesigned models comprises at least one of an ImageNet model, an AlexNet model, a you only look once (POLO) model, an Inception model and a visual geometry group (VGG) model.

5. The system as claimed in claim 2, wherein the one or more predesigned frameworks comprises at least one of a TensorHow framework, a Torch framework, a Keras framework or a Caffe framework.

6. The system as claimed in claim 1, wherein the proposal module is configured to propose and validate a model in a user-defined framework based on a user-defined dataset.

7. The system as claimed in claim 1, further comprising an optimisation subsystem configured to optimise performance of the selected model based on one or more processes.

8. The system as claimed in claim 7, wherein the one or more processes comprises:
a fine-tuning process configured to control one or more parameters of the selected model; and
a fixed-point tuning process configured to optimise architecture by tuning.

9. The system as claimed in claim 1, further comprising a streaming subsystem configured to stream the generated code to an embedded platform for deployment in one or more areas.

10. A method for designing machine and deep learning models for an embedded platform comprising:
storing, by a storage subsystem, a plurality of datasets, one or more augmented datasets, a plurality of models and one or more frameworks;
generating, by a code generation subsystem, a code in a predefined computer language for a selected model;
generating, by an implementation subsystem, one or more test cases and one or more use-cases to test the selected model based on a generated code.

11. The method as claimed in claim 9, further comprising generating a code based on the proposed model in a predefined computer language for porting in correspondence to a heterogeneous hardware platform.
